(19) United States
(12) Patent Application Publication
(10) Pub. No.: US 2007/0006808 A1
(43) Pub. Date: Jan. 11, 2007

(54) Cat loft

(76) Inventors: Amy Scatchard, Los angeles, CA (US); Ken Palmer, Los Angeles, CA (US)

Correspondence Address: JAMES RAY & ASSOCIATES, 2640 PITCAIRN ROAD, MONROEVILLE, PA, 15146, US

(21) Appl. No.: 11/479,038

(22) Filed: Jun. 30, 2006

Related U.S. Application Data
(60) Provisional application No. 60/696,841, filed on Jul. 6, 2005.

(51) Int. Cl. A01K 1/035

(52) U.S. Cl. 119/28.5

(57) ABSTRACT

An apparatus for providing a sleeping place for a pet next to such pet's owner without interfering with such owner's sleeping space. The apparatus comprises a pet bed having a predetermined shape for containing a pad for such pet to sleep on. A pet bed support means is engageable with a bottom portion of the pet bed and is disposed in a substantially horizontal plane when the pet bed is in use. At least one vertical support means is connected to or formed integral with the support means and is adjacent an inner portion thereof and disposed in a substantially vertical direction when such pet bed is in use. There is an adjustment means that is disposed on the vertical support means for permitting adjustment of the height of the pet bed so that the pet bed when in use will be substantially at a same height as a top of the mattress in such owner's bed. A base member is engageable with such at least one vertical support means and with the adjustment means. The base member further is engageable with one of between a mattress and box springs, a bed frame and a bed rail.

### CROSS REFERENCE TO RELATED APPLICATIONS

This application is closely related to and claims benefit from U.S. Provisional Application Ser. No. 60/696,841 filed Jul. 6, 2005.

### FIELD OF THE INVENTION

The present invention relates, in general, to a bed for a pet, and, more particularly, the present invention relates to a bed for a cat which is affixed to an owner's bed thereby permitting such pet to sleep at the same level as the owner without taking up such owner's bed space.

### BACKGROUND OF THE INVENTION

All pets would like to be close to their owners. This is particularly true when the owner is going to bed. Pets, cats in particular, have a great desire to sleep in the owners bed. Cats are especially fond of sleeping against or on the owners leg. Most pet owners enjoy the company and companionship of their cat; however, it can become a problem because it can interfere with the owner's sleep. Having a cat nestled against the owner can create a problem with the owner's freedom to move or roll over in bed.

Thus it would be advantageous if there were a means whereby the cat could enjoy the luxury of sleeping next to its owner without interfering with the owner's freedom to move about the bed as he or she sleeps.

### SUMMARY OF THE INVENTION

The present invention provides an apparatus for providing a sleeping place for a pet next to such pet's owner without interfering with such owner's sleeping space. The apparatus comprises a pet bed having a predetermined shape for containing a pad for such pet to sleep on. There is a pet bed support means that is engageable with a bottom portion of the pet bed and disposed in a substantially horizontal plane when the pet bed is in use, such pet bed support means has a predetermined shape. At least one vertical support means is one of connected to and formed integral with the support means and is adjacent an inner portion thereof and disposed in a substantially vertical direction when such pet bed is in use. The apparatus has an adjustment means that is disposed on the vertical support means for permitting adjustment of the height of the pet bed so that the pet bed when in use will be substantially at a same height as a top of the mattress in such owner's bed. A base member is engageable with such at least one vertical support means and with the adjustment means. The base member further is engageable with one of between a mattress and box springs, a bed frame and a bed rail.

### OBJECTS OF THE INVENTION

It is, therefore, one of the primary objects of the present invention to provide an apparatus which would provide a place for a cat to sleep next to its owner without interfering with the owner's sleeping space.

Another object of the present invention is to provide a place for a cat to sleep next to its owner that is adjustable in height.

Still another object of the present invention is to provide a place for a cat to sleep next to its owner that is secured by having a base that slides between a Mattress and box springs.

Yet another object of the present invention is to provide a a place for a cat to sleep next to its owner that can work with any size mattress or frame.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing the pet bed support system.

FIG. 2 is a perspective view of the apparatus shown in FIG. 1 showing a different adjustment means.

FIG. 3 is a perspective view of the apparatus showing the pet bed with the support system attached to the bed.

FIG. 4 is a perspective view of the apparatus showing the pet bed as it would be attached to the owner's bed.

FIG. 5 is a perspective view of an enlargement of one embodiment of the adjustment means.

FIG. 6 is a perspective view of another embodiment of such pet bed having an oval shape.

FIG. 7 is a perspective view of still another embodiment of such pet bed having a circular shape.

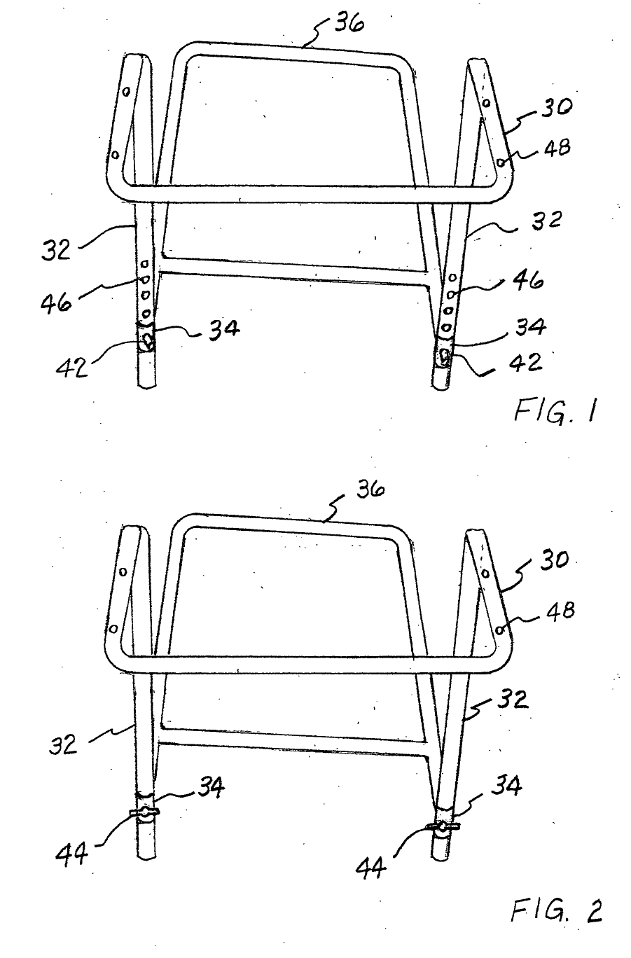

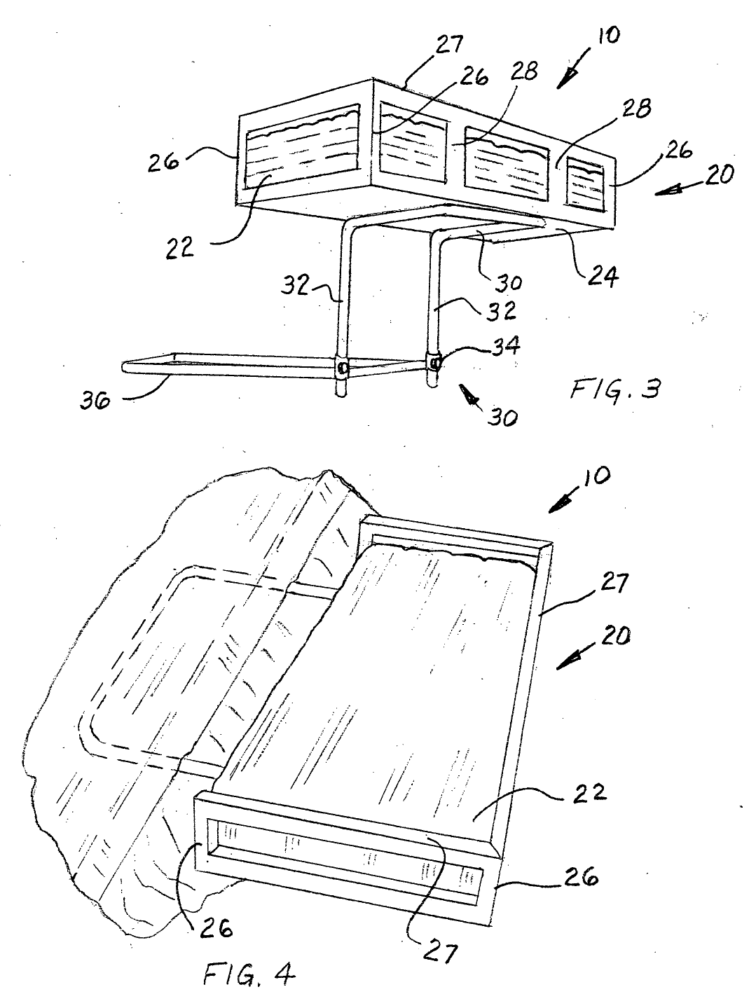

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention was created to allow a cat owner and the pet to enjoy the luxury of sleeping next to each other in total comfort without interfering with each other's space. The invention is an exclusive sleeping bed for the pet that is essentially an extension of the owner's bed. This enables both the owner and the cat the companionship of sleeping together without giving up any personal sleeping space.

The present invention takes the unique approach of allowing the pet to sleep at the same level as the owner, not on a pet bed that rests on the floor. The pet bed also helps to limit the hair and dander to one place making clean up much easier.

The present invention provides an apparatus, generally designated 10, for providing a sleeping place for a pet next to such pet's owner without interfering with such owner's sleeping space. The apparatus 10 comprises a pet bed, generally designated 20, which has a predetermined shape for containing a pad 22 for such pet to sleep on. There is a pet bed support means 30, that is engageable with a bottom portion of the pet bed 20 and disposed in a substantially horizontal plane when the pet bed 20 is in use, such pet bed support means 30 has a predetermined shape. At least one vertical support means 32 is one of connected to and formed integral with the support means 30 and is adjacent an inner portion thereof and disposed in a substantially vertical direction when such pet bed 20 is in use. The apparatus 10 has an adjustment means 34 that is disposed on the vertical support means 32 for permitting adjustment of the height of the pet bed 20 so that the pet bed 20 when in use will be substantially at a same height as a top of the mattress in such owner's bed. A base member 36 is engageable with such at least one vertical support means 32 and with the adjustment means 34. The base member 36 further is engageable with one of between a mattress and box springs, a bed frame and a bed rail.

It is presently preferred that such predetermined shape of such pet bed 20 is substantially rectangular. Such pet bed 20 further includes a substantially flat bottom member 24 upon which the pad 22 rests. There are at least four substantially vertical members 26 that are engageable with a top surface of the substantially flat bottom member 24 and a top railing 27 that is engagageable with an upper surface of the at least four substantially vertical members 26.

As stated previously, the pad 22 is disposed on the substantially flat bottom member 24 and is retained in place by the at least four substantially vertical members 26. The four substantially vertical members 26 are disposed at each corner of the substantially flat bottom member 24.

Such pet bed 20 further includes at least one additional substantially vertical member 28. The at least one additional substantially vertical member 28 is disposed intermediate the pair of the substantially vertical members 26 that are disposed at corners on a side of the pet bed 20 that is opposite the side of pet bed 20 that is adjacent such owner's bed. The side of the pet bed 20 that is adjacent and owner's bed is open.

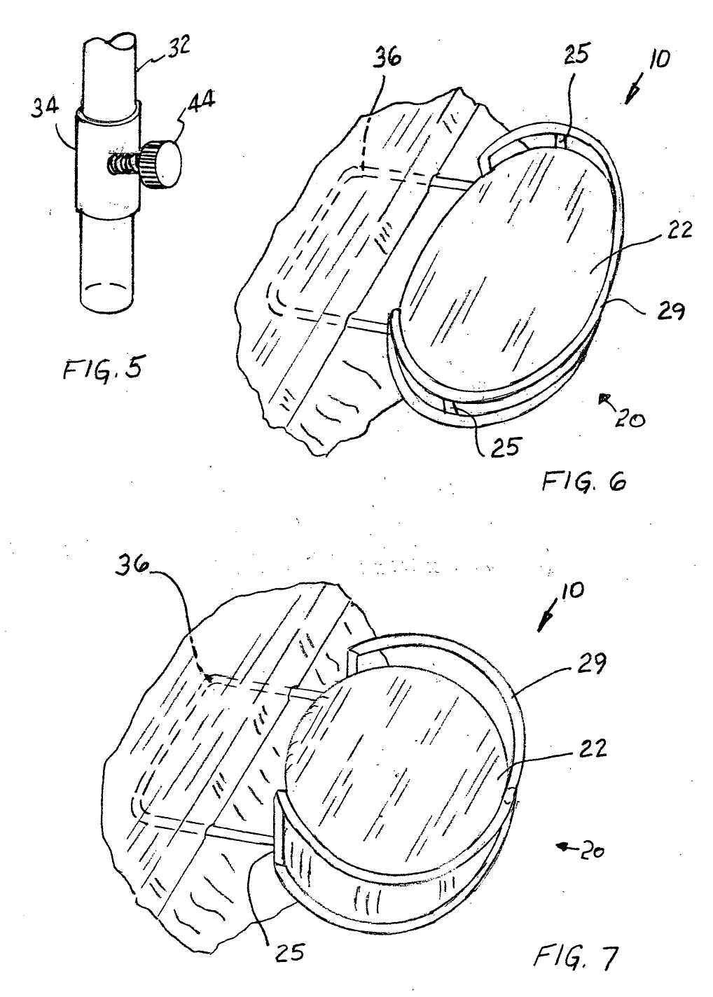

As stated previously it is preferred that such pet bed 20 be rectangular; however, it is within the scope of the invention that such pet bed 20 could have a variety of shapes such as oval or circular as seen in FIGS. 6 and 7. Such pet bed 20 have upright vertical supports 25 and top railing 29. In both of these embodiments the top railing 29 is curved.

The pet bed support means 30 and the at least one vertical support means 32 are formed as an integral unit and are formed of one of plastic and metal. According to a preferred embodiment of the invention such support means 30 is formed of metal and it is even more preferred that such metal is tubular steel.

It is preferred that such base member 36 be engaged by sliding under the mattress of the owner's bed and thus it is held in place by being under the mattress and preferably between the mattress and the box springs.

It is also preferred that such pet bed support means 30 include two vertical support means 32. As is seen in the drawing Figures such support means 30 is U-shaped and each of the vertical support means 32 are engageable with each end of the U-shaped support means 30. Such support means 30 further has two predrilled apertures 48 disposed through each end of the U-shape. The predrilled apertures 48 are for screws to be able to pass through such support means 30 and screw into such base member 36 so as to secure such support means 30 to the base member 36 of such pet bed 20.

The adjustment means 34 includes one of a pin member 42 and a screw 44 disposed at each end of the base member 36 for engagement with each of the two vertical support means 32 for providing a height adjustment for the pet bed 20. Such screw 44 can be a thumb screw, a screw with a knob on the end or a regular screw with a slot in the head. FIG. 5 shows an enlarged view of one embodiment showing one type of screw 44 that is used.

When such apparatus 10 includes such pin member 42 then the vertical support means 32 has a plurality of apertures 46 disposed therein for providing various height adjustments for the pet bed 20. The pin members 42 merely slip into the apertures 46 to adjust the height of the pet bed 20 so that it will be substantially at the same height as the top of the mattress of the owner's bed.

When a screw 44 is employed, the screw 44 is engageable with a threaded aperture formed in each of such two vertical support means 32 and the height of the pet bed 20 is adjusted and the screw 44 screws into the threaded apertures and is tightened against the vertical support means 32 to secure pet bed at whatever the height desired. Use of screws 44 provides an infinite adjustment for a height of the pet bed 20.

By use of either the pins 42 or screws 44 the pet bed can be removed from the base member 36 very easily for storage or in changing the bed linen although the bedding could be changed without removing the cat bed. The base member 36 can remain in place since it does not interfere with anything.

The three sided railing 27 and the vertical members 26,28 on the cat bed 20 keeps the pet's pad 22 or mattress 22 in place and keeps it from sliding anywhere since the other side is against the owner's mattress.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for providing a sleeping place for a pet next to such pet's owner without interfering with such owner's sleeping space, said apparatus comprising:
(a) a pet bed having a predetermined shape for containing a pad for such pet to sleep on;
(b) a pet bed support means engageable with a bottom portion of said pet bed and disposed in a substantially horizontal plane when said pet bed is in use, said pet bed support means having a predetermined shape;
(c) at least one vertical support means one of connected to and formed integral with said support means adjacent an inner portion thereof and disposed in a substantially vertical direction when such pet bed is in use;
(d) an adjustment means disposed on said vertical support means for permitting adjustment of a height of said pet bed so that said pet bed when in use will be one of substantially at a same height as a top of a mattress in such owner's bed and over such owner's mattress; and
(f) a base member engageable with said at least one vertical support means and with said adjustment means; said base member further engageable with one of under a mattress, between a mattress and box springs, a bed frame and a bed rail.

2. The apparatus, according to claim 1, wherein said predetermined shape of said pet bed is one of oval, circular and rectangular.

3. The apparatus, according to claim 2, wherein said predetermined shape of said pet bed is substantially rectangular.

4. The apparatus, according to claim 3, wherein said pet bed further includes;
(a) a substantially flat bottom member;
(b) at least four substantially vertical members engageable with a top surface of said substantially flat bottom member; and
(c) a top railing engagageable with an upper surface of said at least four said substantially vertical members.

5. The apparatus, according to claim 4, wherein said pad is disposed on said substantially flat bottom member and retained in place by said at least four substantially vertical members.

6. The apparatus, according to claim 4, wherein said at least four substantially vertical members are disposed at each corner of said substantially flat bottom member.

7. The apparatus, according to claim 6, wherein said pet bed further includes at least one additional substantially vertical member, said at least one additional substantially vertical member is disposed intermediate a pair of said at least four substantially vertical members, said pair disposed at corners on a side of said pet bed that is opposite a side of said pet bed that is adjacent such owner's bed.

8. The apparatus, according to claim 1, wherein said pet bed support means and said at least one vertical support means are formed as an integral unit.

9. The apparatus, according to claim 8, wherein said pet bed support means and said at least one vertical support means are formed of one of plastic and metal.

10. The apparatus, according to claim 9, wherein said pet bed support means and said at least one vertical support means are formed of metal.

11. The apparatus, according to claim 10, wherein said metal is tubular steel.

12. The apparatus, according to claim 1, wherein said base member is engageable between such mattress and such box spring.

13. The apparatus, according to claim 1, wherein said pet bed support means includes two vertical support means.

14. The apparatus, according to claim 13, wherein said pet bed support means is U-shaped with each of said two vertical support means engageable with each end of said U-shaped support means.

15. The apparatus, according to claim 13, wherein said adjustment means includes one of a pin member and a screw disposed at each end of said base member for engagement with each of said two vertical support means for providing a height adjustment for said pet bed.

16. The apparatus, according to claim 15, wherein said pin member is engageable with a plurality of apertures disposed in said two vertical support means for providing various height adjustments for said pet bed.

17. The apparatus, according to claim 15, wherein said screw is engageable with each of said two vertical support means for providing an infinite adjustment for a height of said pet bed.

18. The apparatus, according to claim 1, wherein said pet bed is made of one of plastic, metal and wood.

19. The apparatus, according to claim 18, wherein said pet bed is made of wood.

20. The apparatus, according to claim 19, wherein said wood is plywood.
